(19) United States
(12) Patent Application Publication
(10) Pub. No.: US 2025/0341462 A1
(43) Pub. Date: Nov. 6, 2025

(54) DISSOLUTION ANALYZER FOR MONITORING OR ANALYZING SUBSTANCE DISSOLUTION INTO A LIQUID OR LIQUID MATRIX, AND DISSOLUTION ANALYSIS METHOD

(71) Applicant: MARAMA LABS LIMITED, Kelburn Wellington (NZ)

(72) Inventors: Eric LE RU, Khandallah, Wellington (NZ); Brendan DARBY, Rathfarnham, Dublin (IE)

(21) Appl. No.: 19/128,363

(22) PCT Filed: Nov. 7, 2023
(86) PCT No.: PCT/IB2023/061208

§ 371 Date: May 8, 2025

(30) Foreign Application Priority Data
Nov. 10, 2022 (EP) 22206532.8

(51) Int. Cl. G01N 21/31; G01J 3/02; G01J 3/08; G01J 3/42; G01J 3/44; G01N 35/00

(52) U.S. Cl. CPC G01N 21/31; G01J 3/0254; G01J 3/08; G01J 3/42; G01J 3/4412; G01N 35/00; G01N 2021/3148; G01N 2035/00198; G01N 2201/065

(57) ABSTRACT

Dissolving activity analyzer including an integrating cavity comprising a reflective inner wall or walls, and configured to receive a cuvette containing liquid sample. The integrating cavity comprises a light inlet port and a light outlet port, the light inlet port being configured to receive light from a light source and the light outlet port being configured to deliver light to a spectrometer. The dissolving activity analyzer is configured to operate in a diffusely reflecting mode in which light from the light source follows a light path from the inlet port into the integrating cavity, is incident onto the reflective inner wall or walls and is diffusely reflected, such that the light from the light source irradiates the liquid sample before being transmitted through the light outlet port and received by the spectrometer to provide an absorbance spectrum of the liquid or liquid matrix contained in the liquid sample.

### CROSS-REFERENCE TO RELATED APPLICATIONS

The present application claims priority to EP Patent Application EP22206532.8 filed on Nov. 10, 2022, the entire contents thereof being herewith incorporated by reference.

### FIELD OF THE INVENTION

The present invention relates to monitoring or analyzing a substance dissolving into parts or elements inside a liquid or inside a liquid matrix, and, in particular, relates to a dissolution analyzer and dissolution analysis method for monitoring or analyzing substance dissolution into parts or elements inside a liquid or inside a liquid matrix.

### BACKGROUND

Monitoring and quantifying the rate at which substances, such as tablets and pharmaceutical products, dissolve into a liquid, is a crucial process in developing and manufacturing products.

Monitoring the release of substances into a liquid as the substance dissolves into the liquid is called dissolution testing. Applications of dissolution testing include monitoring the release profile of vitamins from a tablet once placed into a liquid matrix, for consumption by a human, or the understanding of the release profile of the active ingredient of a drug into the body.

In pharmaceutical applications, dissolution studies are a regulated step in the production and quality assurance of drug product development, and products developed must conform to accepted release profile guidelines.

Absorption spectroscopy, using an ultraviolet-visible (UV-Vis) spectrophotometer, is a common tool used to monitor and quantify the dissolution of a substance into a liquid. Typically, a spectral region where the active ingredient being monitored absorbs light is selected. As the product dissolves, the active ingredient is released into the dissolution liquid matrix, and the UV-Vis spectrum of the solution is measured. The intensity of the absorbance in the region of interest is determined, which can be related to the concentration of the active ingredient present in the liquid at the current time. As dissolution continues, sequential sampling of the solution over time and measurement of the absorbance spectrum allows the concentration of active ingredient released into the solution as a function of time to be determined, thus producing what is known as a dissolution curve.

However, in order to obtain an accurate absorbance measurement, dissolution related processing steps, including, for example, filtration, centrifugation, precipitation or de-gassing, need to be performed on the sample before being analyzed in the UV-Vis spectrophotometer. Not only do these dissolution related processing steps increase significantly a sample processing, it also imposes the use of consumables, such as pipette tips, filters and sample containers that has a negative environmental impact.

This additionally increases the measurement cost. The additional dissolution related processing steps may also introduce unwanted errors and inaccuracies into the resulting absorbance measures.

While one solution to these inconveniences could be to envisage a measurement method in which such dissolution related processing steps are not performed, the drawback of such a method is that traditional spectrophotometers will inaccurately measure the absorbance of a sample when the liquid sample has background turbidity. Background sample turbidity, caused by light scattering from suspended particulates or bubbles provided into the liquid during dissolution activity, will contribute to, or saturate, absorbance measurements, thus hindering the accurate measurement of the ingredient concentration in the liquid.

In many instances of dissolution, such as dissolving a tablet or an effervescent tablet into a liquid, the sample will have high levels of turbidity, caused by large chunks or particulates of undissolved tablet, excipient material, or from bubbles produced by the dissolution process. Consequently, in order to obtain an accurate absorbance measurement to determine accurate dissolution characteristics, the above-mentioned processing steps, including, for example, filtration, centrifugation, precipitation or de-gassing, need to be performed on the sample before being analysed in a UV-Vis spectrophotometer.

If the above processing steps to remove turbidity are not undertaken, dissolution curves will be highly susceptible to sample scattering, and thus will provide incorrect information on the dissolution kinetics of the ingredients.

Additionally, traditional ultraviolet-visible (UV-Vis) based methods are also susceptible to errors from settling of the sample, because the beam of light only probes the sample at a defined height; any substance that settles to the bottom of the sample container will not be included in the measurement and the measured absorbance can give a lower value than the actual concentration of substance in the liquid. Similarly, the potential for turbidity-causing particulates to settle to the bottom of the container will also influence the absorbance results obtained using traditional UV-Vis based methods, leading to further inaccuracies in substance concentrations.

### SUMMARY

It is therefore one aspect of the present disclosure to provide a dissolving activity analyzer, or a dissolution analyzer for measuring, monitoring or analyzing substance dissolution into a liquid or liquid matrix. The dissolution analyzer includes:
an integrating cavity comprising a reflective inner wall or walls, and configured to receive a cuvette containing liquid sample within the integrating cavity,
wherein the integrating cavity comprises at least one light inlet port and at least one light outlet port, the or each light inlet port being configured to receive light from at least one light source and the or each light outlet port being configured to deliver light to a spectrometer;
wherein the dissolution analyzer is configured to operate in a diffusely reflecting mode in which light from the light source follows a light path from the or one of the inlet port(s) into the integrating cavity, is incident onto the reflective inner wall or walls of the integrating cavity and is diffusely reflected within the integrating cavity, such that the light from the light source irradiates the liquid sample before being transmitted through the or one of the light outlet port(s) and received by the spectrometer for wavelength analysis of the light to provide an absorbance spectrum of the liquid or liquid matrix contained in the liquid sample.

The dissolving activity device or analyzer assures that light scattering during the dissolving activity is not lost, and is collected and measured to permit a more accurate absorbance to be measured or determined and more accurate dissolution characteristics to be measured or determined.

Particular embodiments of the dissolution analyzer and other advantageous features are recited in the dependent claims.

It is a further aspect of the present disclosure to provide a dissolution analysis method for measuring, monitoring or analyzing at least one substance during dissolution of the at least substance SB into a liquid, liquid matrix or liquid sample, or for measuring, monitoring or analyzing at least one substance SB that is dissolving into a liquid, liquid matrix or liquid sample.

The method comprises the steps of:
providing the dissolution analyzer or the dissolving activity analyzer as described herein; and
carrying out measurements, using the dissolution analyzer or the dissolving activity analyzer in the diffusely reflecting operation mode during a release of at least one substance from at least one substance carrier into the at least one liquid or liquid matrix contained in a liquid sample.

The method may also include determining a plurality of absorption spectra over a time duration during the release of the at least one substance from at least one substance carrier into the at least one liquid or liquid matrix.

The method may also include determining a substance release profile for the at least one substance based on the determined plurality of absorption spectra.

Specific embodiments of the dissolution analysis method and other advantageous features are recited in the dependent claims.

The invention overcomes the shortcomings of traditional UV-Vis based methods for dissolution testing by employing an integrating-cavity based spectrophotometer to perform the absorbance measurements. The use of an integrating cavity based apparatus allows to eliminate the effects of scattering on the measured absorbance spectrum, thereby producing a “pure absorbance” spectrum of the sample, which more accurately represents the concentration of the substance of interest, without the need to perform the above-mentioned processing steps prior to measurement, that is without the need to filter or pre-process samples to remove turbidity-causing components.

Advantageously, this solution assures that no centrifugation, filtering, precipitation, degassing or other such dissolution related processing step is required prior to measurement. No dissolution related processing step to remove turbidity of the sample is required to obtain an absorbance spectrum, and therefore a dissolution curve, thus saving time and providing results much more rapidly. Importantly, the environmental impact is significantly reduced thanks to the removal of the need to use consumables in the processing steps, such as filters and pipette tips. There is also the additional benefit of a cost reduction brought about by this removal.

Moreover, accuracy can be improved, because the sample is not processed and therefore the measurement is more representative of the sample in its current state.

Importantly, the dissolution measurements and dissolution curves will be unaffected by sample scattering, and therefore will provide smoother and more accurate information on the dissolution kinetics of the substance into the liquid.

Furthermore, errors from sample settling are reduced, because the integrating cavity approach probes the entire sample volume, compared to the standard transmission-based geometry which only probes a specific region of the sample.

The solution provided by the present invention has never been used, disclosed nor suggested as a solution to the previously mentioned problem of additional sample processing steps relating to obtaining dissolution measurements and dissolution measurements, integrating cavities have not been used or suggested before as a way to measure and/or monitor dissolution curves and remove the necessity of additional sample processing steps prior to measurement.

Indeed, the effect of turbidity on dissolution curves has not been studied before and has only now been demonstrated in this disclosure by the Inventors using an integrating cavity to obtain the “true absorbance” of the sample and simultaneously make a comparison with the traditional UV-Vis based results.

The Inventors also demonstrate herein how attempting to remove a background turbidity using a background subtraction from the UV-Vis based results is insufficient to obtain a smooth dissolution curve that is unaffected by sample turbidity.

The dissolution analyzer according to the present disclosure may further include a light path adjuster configured to selectively adjust a light path through the integrating cavity such that at least two distinct light paths are provided. When the light path adjuster is in a first configuration, the dissolution analyzer is in a transmission mode in which light from the light source follows a first light path from the or one of the light inlet port(s) to the liquid sample such that the light from the light source irradiates the liquid sample directly before the light transmitted by the sample is transmitted through the or one of the light outlet port(s) and received by the spectrometer for wavelength analysis of the light to provide an extinction spectrum of the liquid sample. When the light path adjuster is in a second configuration, the dissolution analyzer is in the diffusely reflecting mode in which light from the light source follows a second light path from the or one of the inlet port(s) into the integrating cavity, is incident onto the reflective inner wall or walls of the integrating cavity and is diffusely reflected within the integrating cavity, such that the light from the light source irradiates the liquid sample before being transmitted through the or one of the light outlet port(s) and received by the spectrometer for wavelength analysis of the light to provide an absorbance spectrum of the liquid or liquid matrix contained in the liquid sample.

The dissolution analyzer may in particular be used to obtain spectra being the absorption and extinction spectra of the sample, whereby using a suitable calibration procedure implemented by one or more electronic data processors yields absorbance and extinction spectra that are defined for a given path length through the sample.

By providing a dissolution analyzer which can be used in each of the above configurations it is possible to obtain quantitative spectra where the path length of light through the sample in each configuration is well defined so that the data obtained in each configuration are relatable.

The dissolution analyzer may be configured such that, when in the second configuration, light from the second light path is transmitted:
a) directly from an inlet port onto the wall or walls of the integrating cavity; and/or
b) directly from an inlet port, onto and through the sample and subsequently onto the wall or walls of the integrating cavity.

Thus, when in the second configuration, the second light path may be transmitted from the inlet port either first through the sample or directly onto the cavity wall or walls. With either variant, the apparatus is configured such that the outlet port that is used in the second configuration does not look at the inlet port. In other words, the outlet port used in the second configuration “faces” the walls of the integrating cavity. An outlet port for example can be at 90° to an inlet port, or any other position on the integrating cavity. The relative position of the inlet port and outlet port used in the second configuration is such that the spectrometer does not collect the incident light or the light directly transmitted from the sample.

Preferably, using a suitable calibration procedure yields absorbance and extinction spectra that are defined for a given path length through the sample.

A preferred implementation of the second configuration is to position the outlet port such that it directly faces an area of the cavity wall that the light from the inlet port does not directly illuminate. The dissolution analyzer, used in both configurations and with a suitable calibration procedure, yields both the extinction and absorption spectrum of the liquid sample, where the path length through the sample in both said configurations is well defined, such that the spectra obtained give wavelength-dependent extinction and absorption coefficients of the sample respectively across the wavelength range of the light illuminating the sample.

The dissolution analyzer may comprise one or more integral light source(s), or the light source may be configured to be connected to one or more separate light source(s).

The dissolution analyzer may further comprise an integral or remote controller configured to control the light path adjuster to selectively adjust the path of light through the dissolution analyzer. The controller is preferably configured to control the spectrometer, and in particular is configured to process the light received by the spectrometer for wavelength analysis of the light to provide the extinction and/or absorbance spectrum of the liquid sample contained in the cuvette. The spectrometer may be integral with the dissolution analyzer. The controller or controllers may be configured to control one or more of:
a) switching between the first and second configurations;
b) acquiring spectra from the integrating cavity;
c) choosing operating conditions;
d) displaying spectra on a display of the dissolution analyzer, or of the controller, or in communication with the dissolution analyzer or controller;
e) saving data on a memory of the dissolution analyzer, or of the controller, or in communication with the dissolution analyzer or controller;
f) a user-interface of the dissolution analyzer, or of the controller, or in communication with the dissolution analyzer or controller, that interacts with the dissolution analyzer and allows a user to control the position of the light path adjustment mechanism. The light path adjuster may comprise at least one movable optical element configured to manipulate light incident on the optical element from the light source, the light path adjuster being configured to adjust the movable optical element to selectively provide the first and second light paths. The optical element may be adjustable by moving the optical element with respect to the integrating cavity from a first position in which the light travels along the first light path, and a second position in which the light travels along the second light path.

The integrating cavity comprises orthogonal longitudinal, vertical, transverse axes, and any one or more of the following positional characteristics of the optical element may be adjusted with respect to any one or more of the axes:
a) longitudinal position;
b) vertical position;
c) transverse position
d) orientation;
e) inclination.

A plurality of movable optical elements may be provided. The movable optical element is preferably selected from any one or combination of:
a prism;
a lens;
a mirror;
a diffraction grating;
a fibre optic cable;
the light source;
a shutter.

The light path adjuster may additionally or alternatively comprise at least one fixed optical element which is not adjustable with respect to the integrating cavity. The fixed optical element may be configured to manipulate the light from the light source prior to the light inlet port. The fixed optical element may be configured to manipulate the light from the light outlet port.

The fixed optical element may be selected from any one or combination of:
a) a prism;
b) a lens;
c) a mirror;
d) a diffraction grating;
e) a fibre optic cable;
f) the light source.

The light path adjuster may comprise at least one electronic controller operative to effect selective operation of one or more light sources, to selectively provide the first and second light path.

The dissolution analyzer may comprise at least first and second light sources, the controller being configured to control each light source independently. The light sources could be switched on and off in a blinking or sequential fashion wherein in configuration one the first light source is switched on and in configuration two the second light source is on with the first off. The light sources may be controlled such that both or all light sources can be switched off, to acquire a dark spectrum.

The light path adjuster may be positioned:
a) between the light source and the light inlet port and/or
b) between the spectrometer and the light outlet port.

A plurality of light path adjustment mechanisms may be provided. A plurality of light inlet ports may be provided, the light path adjuster being configured to provide the first light path by directing light from the light source through a first light inlet port, and to provide the second light path by directing light from the light source through a second light inlet port. A plurality of light outlet ports may be provided, the first light path directing light from the integrating cavity through a first light outlet port, and the second light path directing light from the integrating cavity through a second light outlet port.

The integrating cavity may comprise any one of:
a) a diffusely reflecting spherical integrating cavity;
b) a cylindrical cavity;
c) a cuboidal or square cavity.

It will be appreciated that the integrating cavity may be any other shape or combination of shapes.

The integrating cavity may comprise an internal coating configured to provide any one or more of:
a) specular reflectance;
b) diffuse reflectance;
c) reflectance in the UV light spectrum;
d) reflectance in the visible light spectrum;
e) reflectance in the infra-red spectrum.

The light source may comprise any one or more of:
a) a quartz-halogen source;
b) an LED;
c) a laser;
d) any polychromatic source.

The shape of the cuvette may be:
a) square;
b) plate-like;
c) cylindrical;
d) spherical;
The dissolution analyzer may be a UV-VIS spectrometer dissolution analyzer.

The dissolution analyzer may further comprise a sample holder configured to retain a cuvette containing liquid sample within the integrating cavity.

The light source may comprise first and second LED light sources, and the light path adjuster comprises a controller configured to control the first and second LED light sources such that when in the first configuration, the first LED light source is controlled to provide light on the first light path, and when in the second configuration the second LED light source is controlled to provide light on the second light path.

Light from each LED light source may be delivered to the integrating cavity via a respective fibre optic cable. Each LED light source may deliver light to a respective light inlet port. Each light path delivers light through a respective light outlet port.

The first LED light source may be associated with a collimation lens positioned between the first LED light source and the light inlet port associated with that LED light source The apparatus may further comprise first and second outlet ports, and a beam splitter configured to selectively allow light from the first and second outlet ports to be transmitted to the spectrometer.

The above and other objects, features and advantages of the present invention and the manner of realizing them will become more apparent, and the invention itself will best be understood from a study of the following description with reference to the attached drawings showing some preferred embodiments of the invention.

### A BRIEF DESCRIPTION OF THE SEVERAL VIEWS OF THE DRAWINGS

FIG. 1 shows an exemplary substrate or carrier that is an effervescent tablet of berry-flavored vitamin B and vitamin C supplement, placed in water and for which dissolution of the tablet is occurring. Exemplary measurements according to the present invention were performed using this exemplary substrate or carrier.

FIGS. 2A and 2B show measured absorption spectra and extinction spectra measured during the dissolution of the tablet of FIG. 1 in water.

FIGS. 2A and 2B show measured absorption spectra and extinction spectra measured over time during the dissolution in water of a portion of a tablet that is the exemplary ‘berry’ flavored sample tablet. FIG. 2C shows these absorption spectra and extinction spectra measurements at a specific spectral region or value of interest, that was chosen based on the spectral profile of the substance under measurement, monitored over time to determine a time dependence of the substance dissolution. For the exemplary ‘berry’ flavored samples investigated, the spectral value of interest of 469 nm was chosen.

FIG. 3 shows similar absorption spectra and extinction spectra measurements to those of FIG. 2C at a specific spectral region or value of interest, that was chosen based on the spectral profile of the substance under measurement that is an ‘orange’ flavored tablet sample, the spectral value of interest chosen was 448 nm.

FIGS. 4A and 4B show measured absorption spectra and extinction spectra measured over time during the dissolution in water of a portion of another sample that is a vitamin C supplement tablet.

FIG. 5 is a schematic view of example components of a dissolution analyzer in accordance with the present disclosure.

FIGS. 6A and 6B are schematic views of a first embodiment of a dissolution analyzer in accordance with the present disclosure, in first and second configurations.

FIGS. 7A and 7B are schematic views of a second embodiment of a dissolution analyzer in accordance with the present disclosure, in first and second configurations;

FIG. 8 is a schematic view of a third embodiment of a dissolution analyzer in accordance with the present disclosure, simultaneously illustrating first and second configurations of the dissolution analyzer.

FIG. 9 is a schematic view of a fourth embodiment of a dissolution analyzer in accordance with the present disclosure, simultaneously illustrating first and second configurations of the dissolution analyzer.

FIG. 10 is a schematic view of a fifth embodiment of a dissolution analyzer in accordance with the present disclosure, simultaneously illustrating first and second configurations of the dissolution analyzer.

FIG. 11 is a schematic view of a sixth embodiment of a dissolution analyzer in accordance with the present disclosure, simultaneously illustrating first and second configurations of the dissolution analyzer.

Herein, identical reference numerals are used, where possible, to designate identical elements that are common to the Figures. Also, the images are simplified for illustration purposes and may not be depicted to scale.

### DETAILED DESCRIPTION OF SEVERAL EMBODIMENTS

The accompanying drawings constitute part of this specification, illustrate the presently preferred embodiments of the invention, and together with the general description given above and the detailed description given below, serve to explain features of the invention.

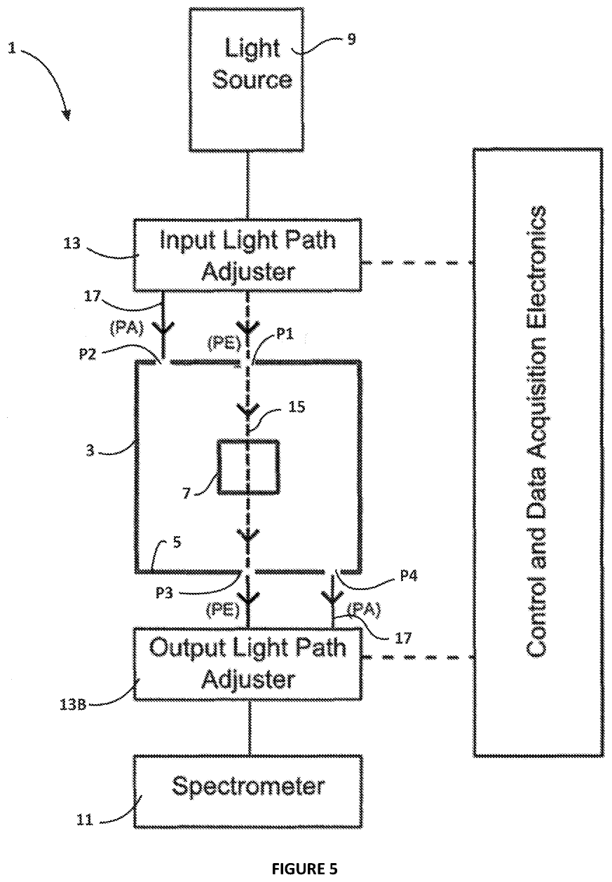

FIGS. 5 to 11 schematically show exemplary dissolution analyzers 1 or dissolution devices 1 of the present disclosure.

During the action or process of dissolution, a substance or item SB is dissolving into a liquid or liquid matrix LQ, out of or away from a host or carrier CR in which the substance or item is contained, held or carried prior to being brought into contact with or placed in the liquid.

The dissolution analyzer 1 of the present disclosure is, for example, a dissolution activity analyzer 1 configured to monitor dissolution activity of the substance into the liquid, or a dissolution kinetic process analyzer 1 configured to monitor the kinetic dissolution process of the substance into the liquid.

The dissolution analyzer 1 of the present disclosure is, for example, a releasing-substance analyzer 1 or a dissolving-substance analyzer 1 or a dissolving substance activity analyzer 1, the releasing or dissolving substance being provided to a liquid or liquid matrix by the host or carrier in which the item or substance is contained, held or carried prior to being brought into contact with or placed in the liquid or liquid matrix. The substance or item is being dissolved into the liquid or liquid matrix.

The dissolution analyzer 1 measures, analyses or monitors dissolution action or dissolution activity in the liquid or liquid matrix during release of at least one substance or item into the liquid or liquid matrix.

The substance or item SB is held, carried, or contained in at least one (substance) carrier CR or at least one (substance) substrate CR. The substance or item SB is released from the carrier or substrate CR when the carrier or substrate CR, or a portion thereof, is placed into the liquid or liquid matrix LQ.

The dissolution analyzer 1 measures, analyses, or monitors the dissolution kinetic process that releases the substance or item; or measures, analyses or monitors a dissolution rate or dissolution profile of the substance released into the liquid.

The dissolution analyzer 1 is, for example, a substance-into-liquid dissolution analyzer 1, or a substance-into-liquid dissolving action analyzer. The dissolution analyzer 1 is, for example, a dissolution analyzer 1 for monitoring or analyzing substance dissolution into a liquid or into a liquid matrix or into a liquid sample.

During dissolution, at least one substance or item dissolves or diffuses into the liquid, liquid matrix or liquid sample. The dissolution or diffusion generates light scattering by the substance or item that dissolves or diffuses into the liquid, liquid matrix or liquid sample. The dissolution or diffusion of the dissolving substance or item generates a turbid liquid or turbid liquid matrix.

The at least one substance or item becomes incorporated into the liquid or liquid matrix.

A mixture, a solution, a suspension, or an emulsion is, for example, formed by the dissolution of the substance into the liquid. The substance(s) or item(s) diffuse into the liquid to form, for example, a mixture, a solution, a suspension, or an emulsion.

The substance or item is, for example, a solid substance or solid item, or a gas substance or gas item, or a liquid substance or liquid item.

The carrier or substrate may, for example, comprises or consist of a tablet, a capsule, or a powder or a granule.

The carrier or substrate may, for example, contain and release a plurality of different items or different substances into the liquid in addition to the substance or item of interest. Dissolution characteristics of only one of the plurality of items or substances may be measured, monitored, or analyzed, that of the substance or item of interest. Several substances or items may be of interest, and dissolution characteristics of the plurality of items or substances may be measured, monitored, or analyzed. Alternatively, dissolution characteristics of a subset of the plurality of items or substances may be measured, monitored, or analyzed.

The carrier or substrate may, for example, include elements that assist the dissolution process or substance diffusion, for example, sodium carbonate or sodium bicarbonate.

The monitored substance of interest or item of interest is, for example, a target substance or active substance (or item) that is being released or made available for use, for exploitation or for consumption by a human or animal.

The dissolution characteristics of this target or active substance to be monitored may be required to respect a particular dissolution standard or substance release conditions. The monitoring and measurements may, for example, allow to assure a consistent quality in production of the carriers providing such substances via dissolution release, or may, for example, assure that a consistent release profile is provided by such carriers.

The substance or item that is monitored can be any substance or item intended to be dissolved or released into a liquid or liquid matrix. Dissolution characteristics depend on numerous factors, including surface area, temperature, and agitation. The dissolution analyzer 1 allows dissolution characteristics to be determined and verified for compliance with product requirements.

The substance or item may, for example, comprise or consist of a nutrient such as a vitamin or a mineral, or may be an inorganic compound. The substance or item may, for example, be a drug, for example, a pharmaceutical drug. Dissolution of a drug or dissolution of a drug according to a specific release profile may be important for therapeutic effectiveness.

The liquid or liquid matrix is, for example, water but can be any liquid or liquid matrix into which dissolution of the substance or item of interest is envisaged. During measurements, the liquid or liquid matrix is contained or held inside a cuvette received in the dissolution analyzer 1. The substance or item to be analyzed or monitored is introduced into the cuvette for measurement, for example, by introducing the carrier or a portion thereof into the cuvette, and performing dissolution measurements during substance release from the carrier into the liquid inside the cuvette.

FIG. 5 shows an exemplary embodiment of the above-mentioned analyzer 1 for measuring spectra of a liquid sample during substance, ingredient or item dissolution into the liquid or liquid matrix of the liquid sample. The dissolution analyzer 1 is configured to be able to measure multiple optical properties of a liquid sample, of which the properties are the wavelength dependent extinction and absorption coefficients of the liquid.

The dissolution analyzer 1 comprises, for example, an integrating cavity 3 comprising reflective inner walls 5, and configured to retain a cuvette 7 containing liquid or liquid matrix within the integrating cavity 3, with light from a light source 9 being delivered into the cavity 3 via different light paths 15, 17 entering the cavity 3, the different light paths 15, 17 are selectively adjustable via a light path adjuster 13. The light path adjuster 13 is used to deliver the light into the cavity 3 through at least one inlet port P1, P2 along different paths depending on the configuration of the light path adjuster 13.

The dissolution analyzer 1 further comprises at least one light outlet port P3, P4 configured to deliver light to a spectrometer 11. In some examples, an output light path adjuster 13B is provided that controls the path of light from the integrating cavity 3 to the spectrometer 11.

In the first configuration, the dissolution analyzer 1 is in a transmission mode, where the input path adjuster 13 is positioned such that the light from the light source 9 entering the cavity 3 through an inlet port P1 so as to directly illuminate the liquid contained in the cuvette 7 and the outlet light path adjuster 13B is configured such that the light collected through an outlet port P3, and sent to the spectrometer 11 so that a proportion of light from the light source 9 is directly transmitted by the sample after illuminating the sample. In this configuration, the extinction spectrum of the sample is obtained.

In the second configuration, the dissolution analyzer 1 is in a diffusely reflecting mode, where the inlet light path adjuster 13 is positioned such that the light from the light source 9 entering the cavity 3 through an inlet port P2 can either directly illuminate the liquid contained in the cuvette 7 or can be incident on the cavity wall 5 and be diffusely reflected within the cavity 3 before interacting with the liquid sample. Furthermore, in this second configuration, the outlet light path adjuster 13B is configured such that the light transmitted and/or reflected by the sample and collected through outlet port P4 and sent to the spectrometer 11 has undergone at least one reflection from the cavity walls 5 before entering the outlet port P4. In this configuration, the absorption spectrum of the sample is obtained, free from the effects of scattering by the liquid sample.

The means of switching between configuration modes is, for example, provided by one or more electronic controllers that select the configuration of both the inlet light path adjuster 13 and the outlet light path adjuster 13B (if provided), to obtain either the extinction or absorption spectrum of the liquid sample depending on the configuration mode that is selected.

The dissolution analyzer 1, and method of use of the dissolution analyzer 1, allows the measurement of the extinction and absorption spectrum of a liquid sample, for example, a liquid into which a substance or item or ingredient is being liberated or dissolved, using a single apparatus.

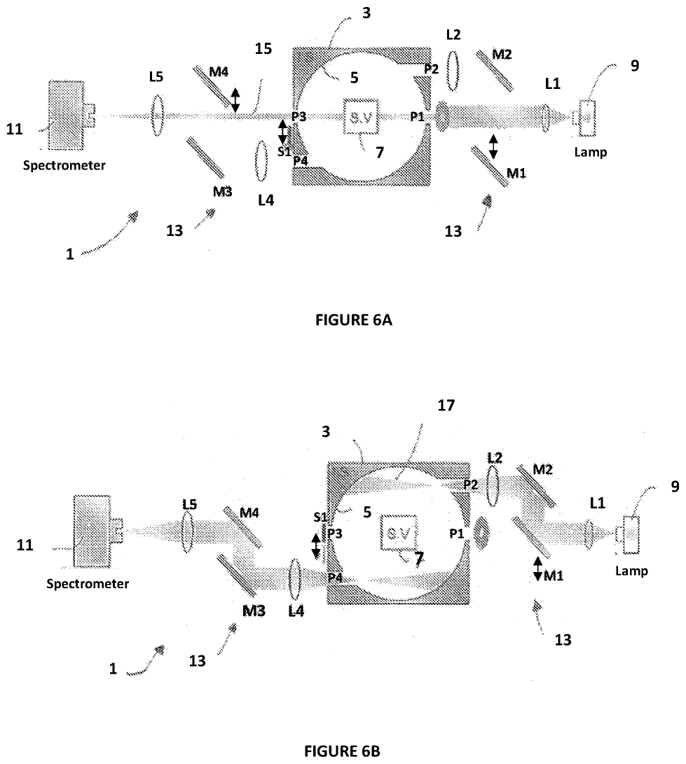

Referring now to FIGS. 6A and 6B, a first embodiment of a dissolution analyzer 1 for measuring spectra of a liquid sample comprises an integrating cavity 3 comprising a reflective inner wall or walls 5, and configured to retain a cuvette 7 containing liquid sample within the integrating cavity 3. The integrating cavity 3 comprises at least one light inlet port P1, P2 and at least one light outlet port P3, P4, the light inlet port(s) P1, P2 being configured to receive light from a light source 9 and the light outlet port(s) P3, P4 being configured to deliver light to a spectrometer 11.

The dissolution analyzer 1 further comprises a light path adjuster 13 configured to selectively adjust a path of light through the integrating cavity 3 such that at least two distinct light paths 15, 17 are provided.

When the light path adjuster 13 is in a first configuration, the dissolution analyzer 1 is in a transmission mode in which light from the light source 9 follows a direct light path 15 from the, or one of the, light inlet ports P1, to the liquid sample such that the light from the light source 9 irradiates the liquid sample directly before being transmitted through the, or one of the, light outlet ports P3, P4 and received by the spectrometer 11 for wavelength analysis of the light to provide an extinction spectrum of the liquid sample in the cuvette 7.

When the light path adjuster 13 is in a second configuration, the dissolution analyzer 1 is in a diffusely reflecting mode in which light from the light source 9 follows a light path 17 from the, or one of the, inlet ports P1, P2 into the integrating cavity 3, and is either:
a) incident directly onto the reflective inner wall or walls 5 of the integrating cavity 3 and is diffusely reflected within the integrating cavity 3, such that the light from the light source 9 irradiates the liquid sample indirectly; or
b) incident directly (not shown) onto the liquid sample 7 such that the light from the light source 9 irradiates the liquid sample directly and the light transmitted and/or reflected by the sample is diffusely reflected within the integrating cavity

The light is subsequently transmitted through the, or one of the, light outlet ports P3, P4 and received by the spectrometer 11 for wavelength analysis of the light to provide an absorbance spectrum of the liquid sample contained in the cuvette 7.

The dissolution analyzer 1, and method of use of thereof, allows the measurement of the extinction and absorption spectrum of a liquid sample using a single apparatus. The method includes placing a liquid sample, which may be, for example, contained in a standard 1 cm square cuvette 7, in an integrating cavity 3 and delivering light to the sample either in a transmission or diffusely reflecting configuration. The carrier (or a portion thereof) containing the at least one substance to be released into the liquid or liquid matrix, can be inserted into the cuvette prior to positing the cuvette into the integrating cavity 3, or while the cuvette is already positioned inside the integrating cavity 3. In the first configuration, the light transmitted by the sample is sent to a spectrometer 11 and an extinction spectrum is obtained, while in the second configuration light is diffusely reflected within the cavity 3 and interacts with the sample, so that the light scattered by the sample is not lost.

In the second configuration the light may initially interact with the sample in the cuvette, or be incident directly on the walls of the cavity. The spectrum collected by the spectrometer 11 in the second configuration can then be related to the absolute absorption spectrum with suitable calibration and modelling.

Switching between measurement configurations is provided via one or more adjustable optical elements L1-L5, M1-M4, configured to manipulate the light from the light source 9 prior to the light entering the integrating cavity 3. Such optical elements can comprise one or more shutters and/or moveable mirrors that control the light path through the integrating cavity 3, and as such allow both the extinction and absorption spectrum of the liquid to be obtained using a single apparatus 1.

The dissolution analyzer 1 suspends or supports a sample cuvette 7 within an integrating cavity 3, whereby the latter has a specific light inlet/outlet port configuration which, in combination with one or more optical elements, allows two distinct light-paths to be provided through the integrating cavity 3 between the light source 9 and spectrometer 11, and in particular the light detector of or connected to such a spectrometer.

The first and second light paths through the integrating cavity 3 may be provided in a number of different ways, and by varying one or more of at least the following:
a. The number of, and/or position of inlet ports;
b. The number of, and/or position of outlet ports;
C. The number of, and/or position of, and/or type of, movable optical elements;
d. The number of, and/or position of, and/or type of any auxiliary fixed optical elements that may be used;
e. The relative position of the integrating cavity with respect to the light source and/or the spectrometer.

In practice the use of the dissolution analyzer 1 provides one or more of the following advantages:
A method for performing standard UV-VIS measurements as in any other device available on the market with standard cuvettes.
The ability to switch to an absorbance mode to remove any effects of scattering.
Retrieval of both the extinction and absorbance spectra immediately, from the perspective of the user.
Measurement of absorption and extinction spectra as well as dissolution measurements in a single instrument and without user intervention.
Convenient sample replacement through a cavity port, akin to replacement in a standard UV-VIS instrument.
Provides a means to determine the absolute absorbance of turbid/scattering media.

### Different Inlet Ports

With reference to the first example of FIGS. 6A and 6B, light is transmitted from the light source 9 into the integrating cavity 3 along first light path 15 through one of two light inlet ports P1, P2. When the apparatus 1 is in the first configuration, light enters through first light inlet port P1, and is directly incident on the liquid sample in the cuvette 7. The light transmitted by the liquid sample is collected via first light outlet port P3 and is processed in the same way a standard UV-VIS measurement would be done, by measuring the wavelength dependent extinction spectrum of the sample which determines the wavelength dependent extinction coefficient of the sample.

In the second configuration, the light from the light source is sent through P2 along second light path 17 and is directly incident on the reflective walls 5 of the cavity 3 first. The surface of the walls 5 of the cavity 3 is for example, to a good approximation, a perfect diffuse reflector (lambertian surface). The incident light thus spreads diffusely in the cavity 3 and illuminates and interacts with the sample. Light may be absorbed by the sample, but light scattered by the sample remains part of the diffuse illumination present in the cavity 3.

In the second configuration, the light is then collected via second light outlet port P4 that is specifically positioned such that as much as possible of the light directly transmitted or reflected by the sample does not enter outlet port P4 before it is reflected from the cavity walls 5, and is processed by the spectrometer 11, allowing the true absorbance spectrum of the sample to be determined, without spectral light loss due to scattering. Switching between extinction and absorbance modes is done via the light path adjuster without needing to change the sample position or any other optics of the apparatus.

The light path adjuster 13 thus adjusts the light received by the integrating cavity 3 from the light source 9 to provide a first light path 15 in which light is directly incident in the liquid sample and not on the walls 5 of the cavity 3, and a second light path 17 in which light is directly incident on the walls 5 of the cavity 3 but not on the liquid sample.

In the example, the light path adjuster 13 comprises optical elements in the form of two transversely spaced part, angled set of inlet mirrors M1, M2 between the light source 9 and cavity 3, and a corresponding pair of transversely spaced part, angled set of outlet mirrors M3, M4 between the cavity 3 and the spectrometer 11. In this example, the cavity 3 comprises two transversely space apart light inlet ports P1, P2, and comprises two transversely space apart light outlet ports P3, P4. In this example, a plurality of lens L1-L5 are provided in different positions along the first and second light paths 15, 17. The light path adjuster also comprises a movable shutter S1 configured to open and close first outlet port P3.

One inlet mirror M1 and one outlet mirror M4 are both movable along the transverse axis of the cavity 3, whilst second inlet mirror M2 and second outlet mirror M3 are fixed and not movable. In the first configuration, both sets of mirrors are in a position in which they do not impede a notional path from the light source 9, first inlet port P1, the liquid sample, and the first outlet port P3. In this position light from the light source 9 is transmitted along a direct light path 15 and is directly incident on the liquid sample.

In parallel, when mirror M1 is out of the first light path 15, shutter S1 is simultaneously open, allowing light transmitted by the sample to exit the cavity 3 from the extinction light outlet port P3. Moveable outlet mirror M4 is also simultaneously positioned out of the first light path 15 such that the light exiting P3 can be focused directly onto the spectrometer 11 via lens L5.

In configuration 2, the moveable inlet mirror M1 is placed in the light path between the light source 9 and the first inlet port P1, with mirror M1 being positioned at, for example, 45° to the light path such that the light is directed to the fixed mirror M2 which consequently allows the light to be focused into the absorption light inlet port P2 via the focusing lens L2. In this configuration, the light is incident directly onto the interior wall 5 of the cavity 3 and is diffusely reflected within the cavity 3. The light within the cavity 3 is then collected via the outlet port P4 using lens L4 and sent to the spectrometer. Light is prevented from exiting the cavity 3 via the first outlet port P3 because this has been closed by movable shutter S1.

In practice the use of the dissolution analyzer 1 provides one or more of the advantages stated above.

The dissolution analyzer 1 may comprise, or be in communication with, an electronic controller/software configured to perform the measurement i.e. reference and sample measurement, acquisition time, integration time and display of obtained extinction, absorbance and scattering spectra.

### Same Inlet Port

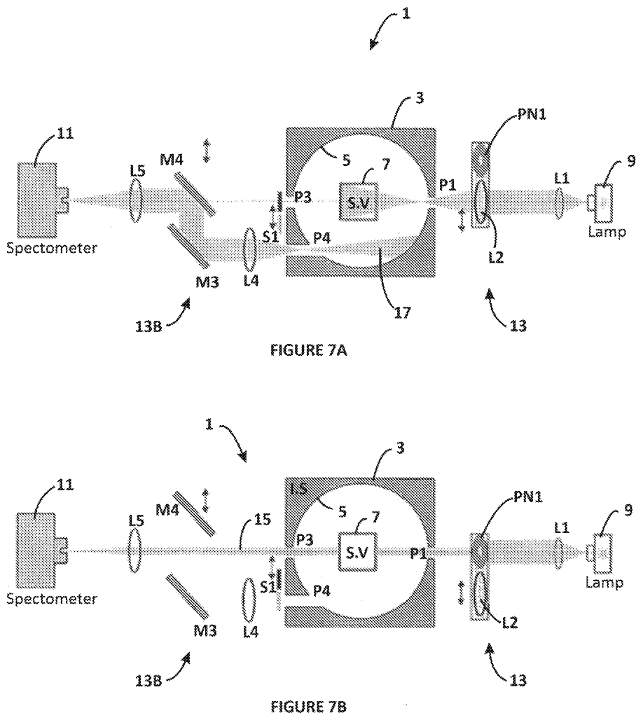

Referring now to FIGS. 7A and 7B, a second embodiment of the dissolution analyzer 1 is provided with like features being given like references. In this example, the dissolution analyzer 1 is similar to that of FIG. 6, but a single light inlet port P1 is provided. The light path adjuster 13 comprises a combined pinhole-lens system comprising pinhole PN1 and focusing lens L2 placed between the light source 9 and the inlet port P1 and the moveable shutter S1 placed after the outlet ports P3 and P4.

In the first configuration, shown in FIG. 7B, the light path adjuster 13 is configured such that such that pinhole PN1 is aligned with the incoming light path and the light entering the inlet port P1 is essentially collimated and in this position light from the light source 9 is transmitted along a direct light path 15 and is directly incident on the liquid sample. In parallel, when pinhole PN1 is in the light path, the shutter is simultaneously closed allowing light transmitted by the sample to exit the cavity 3 from the extinction light outlet port P3. Moveable outlet mirror M3 is also simultaneously positioned out of the first light path 15 such that the light exiting P3 can be focused directly onto the spectrometer 11 via lens L5.

In configuration 2, the light path adjuster 13 is positioned such that the input pinhole PN1 is out of the light path and the focusing lens L2 is in the light path and the incident light from the light source 9 is focused onto the inlet port P1 such that the light is transmitted along a direct light path to the sample but because it has been focused to a point at the inlet port position, the light is divergent such that the light illuminates the entire transverse width of the sample cuvette. In parallel, when focusing lens L2 is in the light path, the shutter S2 is simultaneously open, covering the outlet port P3 with moveable mirror M4 positioned at, for example, 45° to the light path, In this configuration, light scattered, transmitted and reflected by the sample is diffusely reflected within the cavity 3 which then allows light that has been diffusely reflected within the cavity 3 to exit the cavity 3 from the absorption outlet port P4. This light is then collected via the outlet port P4 using lens L4 and sent to the spectrometer via mirror M3 and moveable mirror M4.

### Shutter Selection Avoiding Sample

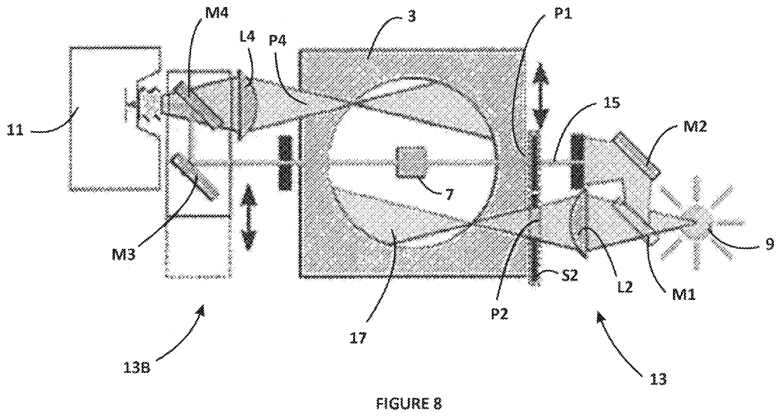

Referring now to FIG. 8, a third embodiment of the dissolution analyzer 1 is provided with like features being given like references. In this example, the movable inlet mirror M1 has been replaced by an inlet shutter S2, and a second fixed inlet mirror M1. The outlet mirrors M3, M4 are together transversely movable from a position in which angled outlet mirror M3 is in the light path of outlet port P3 so as to direct light from first light path 15 onto second outlet mirror M4 and onto spectrometer 11. Outlet shutter S1 comprises a shutter aperture which is aligned with outlet port P3 in this first configuration. Inlet shutter S2 comprises a pair of transversely spaced apart shutter apertures. In the first configuration the shutter S2 is positioned such that one of the shutter apertures is aligned with inlet port P1, but with inlet port P2 closed. Angled, fixed inlet mirrors M1, M2 direct light to inlet port P1. In the second configuration inlet shutter S2 is moved transversely such that inlet port P1 is closed and inlet port P2 aligned with one of the inlet shutter S2 apertures such that light from light source 9 is transmitted directly into inlet port P2. Outlet mirrors M3, M4 are moved transversely so that mirror M3 is not in the light path between outlet port P4 and spectrometer 11.

### Shutter Selection Straight Through Sample

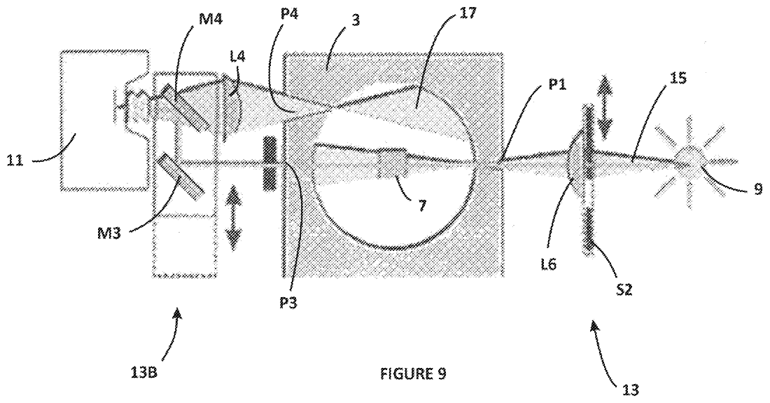

With reference to FIG. 9, a fourth embodiment of the dissolution analyzer 1 is provided with like features being given like references. In this example, the dissolution analyzer 1 is similar to that of FIG. 8, but no inlet mirrors are provided. The inlet shutter S2 is provided adjacent an inlet lens L6. Transverse adjustment of the position of the inlet shutter S2 aligns one or other shutter aperture with the inlet lens L6 and the light source. One inlet shutter aperture is relatively small, and the other is relatively large. By adjusting which aperture is aligned with the light source, in combination with lens L6, it is possible for both light paths 15, 17 to be directly incident on the liquid sample, with the first light path passing through the sample and exiting the cavity via outlet port P3, and the second light path also passing through the liquid sample but diffusing into contact with the walls 5 of the cavity 3 before exiting cavity 3 via second outlet port P4, when outlet shutter S1 closes first outlet port P3.

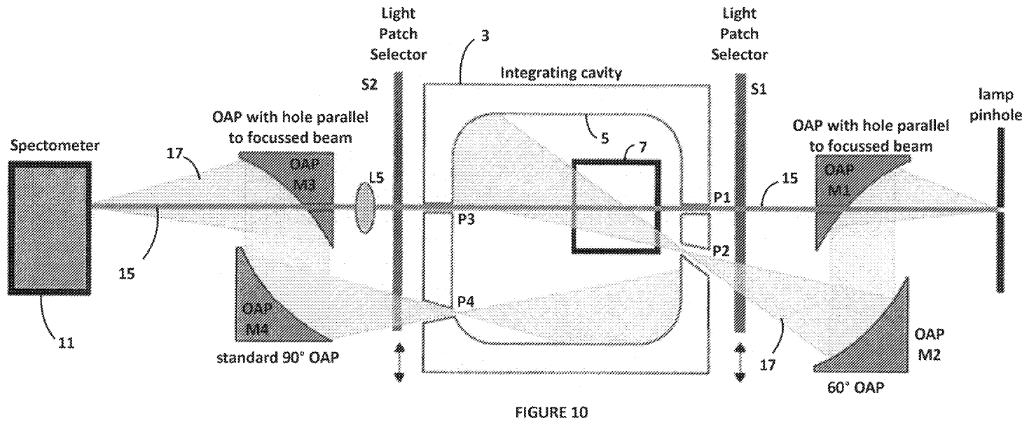

Referring now to FIG. 10, a fifth embodiment of the dissolution analyzer 1 is provided with like features being given like references. In this example, the dissolution analyzer 1 is similar to that of FIGS. 7A and 7B but the manipulation of the optical path for two different configurations is provided via off-axis parabolic (OAP) mirrors instead of lenses and flat mirrors. There are furthermore two inlet ports P1, P2 provided in this embodiment. In this example, the OAP M1 comprises a mirror, placed between the light source 9 and the first inlet port P1, with a hole drilled through the center, parallel to the incident light path, while OAP M2 has no hole drilled and redirects light with an angle, in this example, of 60°, between the light source 9 and the second inlet port P2. The light path adjuster comprises two moveable shutters S1, S2 on the inlet and outlet side of the integrating cavity 3, that move in parallel and depending on their position, block light incoming and outgoing from either ports P1 and P3 simultaneously, or P2 and P4 simultaneously.

In the first configuration, the light path adjuster is positioned such that the light reflected and focused from OAP M2 is blocked from entering the cavity 3 via second inlet port P2, such that only the light passing through the hole in OAP M1 enters the cavity 3 via first inlet port P1, and is transmitted along a direct light path 15. This light is directly incident on the liquid sample 7. In parallel, on the outlet side of the cavity 3, the shutter S2 of the light path adjuster is positioned such that second outlet port P4 is closed and light diffusely reflected within the cavity 3 does not reach the spectrometer 11. In parallel, first outlet port P3 is open, such that the light transmitted by the sample 7 can exit the first light outlet port P3, transmitted through the hole drilled in OAP M3 parallel to the light path, and can be focused directly onto the spectrometer 11 via lens L5.

In the second configuration, the shutter S1 of the light path adjuster is positioned such that the light passing through the hole in OAP M1 is blocked from entering the cavity 3 via inlet port P1. As such, the divergent light reaching OAP M1 is collimated and redirected 90° by OAP M1 onto OAP M2 from which it is then focused and redirected at 60° to the to a point at second inlet port P2. The light entering the cavity 3 is then divergent such that the light illuminates the entire transverse width of the sample cuvette, while not allowing any light to be directly transmitted onto the first light inlet port P1. In parallel, on the outlet side of the cavity 3, the shutter S2 of the light path adjuster is positioned such that outlet port P3 is closed and light directly transmitted by the sample 7 does not reach the spectrometer 11. In parallel, outlet port P4 is open, such that the light scattered, transmitted and reflected by the sample 7 is diffusely reflected within the cavity 3 after which it leaves the cavity 3 via second outlet port P4. This divergent light is then collected via OAP M4, collimated and redirected at 90° by OAP M4, onto OAP M3 from which it is redirected at 90° and focused directly onto the spectrometer 11 by OAP M3.

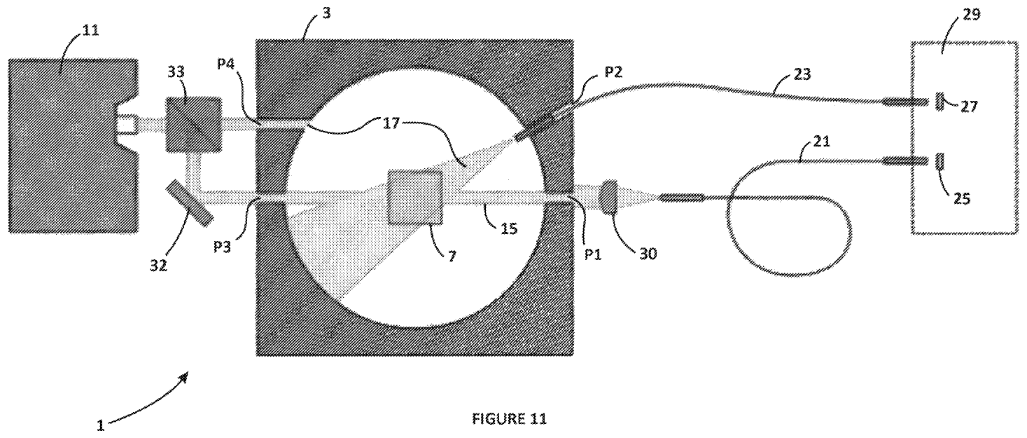

Referring now to FIG. 11, a sixth embodiment of the dissolution analyzer 1 is provided with like features being given like references. In this example, the manipulation of the optical path for two different configurations is provided via a pair of fibre optic cables 21, 23, each of which is associated with a respective light source 25, 27, and with a respective inlet port P1, P2. Each light source 25, 27 may comprise a respective LED source 25, 27 which with an associated LED electronic controller 29 comprise the light adjuster in this example, whereby the provision of light to inlet port P1 or P2 is controlled by suitable activation and deactivation of the LED sources 25, 27 by the controller 29.

In this example, the fibre optic cable 21 supplies light directly to first inlet port P1. Fibre optic cable 23 supplies light to second inlet port P2 via a collimation lens 30.

An outlet mirror 32 and beam splitter 33 are provided between outlet ports P3, P4 and the spectrometer 11 and are configured to allow selectively allow light from first and second outlet ports P3, P4 to reach spectrometer 11 in dependence upon in which configuration the dissolution analyzer is operating.

In the first configuration, the dissolution analyzer 1 is in a transmission mode in which the light path adjuster, namely the controller 29 is controlled such that light is provided from LED source 25, via first fibre optic cable 21 to inlet port P1. Light entering the cavity 3 through inlet port P1 directly illuminates the liquid contained in the cuvette 7 and the outlet light path adjuster, namely outlet mirror 31 and splitter 33, are configured such that the light collected through outlet port P3, and sent to the spectrometer 11, includes a proportion of light from the first LED source 25 is directly transmitted by the sample after illuminating the sample. In this configuration, the extinction spectrum of the sample is obtained.

In the second configuration, the dissolution analyzer 1 is in a diffusely reflecting mode, where the controller 29 controls second LED source 27 to provide light via second fibre optic cable 23 to the second inlet port P2. Light from the LED source 25 entering the cavity 3 through inlet port P2 can either directly illuminate the liquid contained in the cuvette 7 or can be incident on the cavity wall 5 and be diffusely reflected within the cavity 3 before interacting with the liquid sample. In this second configuration, the outlet mirror 31 and/or splitter 33 are configured such that the light transmitted and/or reflected by the sample and collected through second outlet port P4 and sent to the spectrometer 11 has undergone at least one reflection from the cavity walls 5 before entering the outlet port P4. In this configuration, the absorption spectrum of the sample is obtained, free from the effects of scattering by the liquid sample.

The use of independently controllable LED light sources each of which feed a particular inlet port P1, P2 may result in a somewhat simpler apparatus which requires less separate movable and/or fixed optical elements to control the light entering sphere 3, and to allow the dissolution analyzer to operate in the first and second configurations.

In this embodiment, inlet port P2 is non-parallel with inlet port P1, such that light enters the cavity via inlet port P2 at an angle inclined to the major axes of the cavity. The position/angle of the port P2 should be chosen so as to minimize the chance for any Fresnel reflections from the cuvette 7 exiting through the transmission port P3, P4 upon first reflection when the light hits the cuvette 7. The angle of the light path through port P2 can be selected accordingly.

The movable and/or fixed optical elements may, in a dissolution analyzer 1, be selected from:
a. a prism;
b. a lens;
c. a mirror;
d. a diffraction grating;
e. a fibre optic cable;
f. the light source.

### Example Components

Provided below is, a non-limiting outline of example components that can be used with some examples of dissolution analyzers 1:
Light source 9: A tungsten halogen lamp providing light for excitation from 350-900 nm, purchased from ThorLabs.
Moveable Mirrors (M1, M4, in the example of FIGS. 5 and 6): Standard optical mirrors mounted 45° to the light path, that can be translated into and out of the beam path for choosing either the first or second configurations. Purchased from ThorLabs.
Fixed Mirrors (M2, M4, in the example of FIGS. 5 and 6): Standard optical mirrors mounted 45° to the light path that can be translated into and out of the beam path for choosing either the first or second configurations. Purchased from ThorLabs.
Delivery Lens (L2, in the example of FIGS. 5 and 6): Standard convex lens of defined focal length used for the second configuration to focus the incoming light through inlet port P2 onto the cavity walls 5 for absorption measurements. Purchased from ThorLabs.
Integrating Cavity 3:50 mm internal diameter spherical integrating cavity with diffusely reflecting inner walls. The sphere has four ports (P1-P4) drilled in the walls for light delivery and collection and a custom drilled sample port on the north pole for suspending the cuvette 7 in the center of the cavity 3. The integrating cavity 3 is purchased from Avian Technologies. The sphere geometry may be bespoke, to suit the application with which apparatus 1 is used. The cavity 3 may be non-spherical, and could be cylindrical or cuboidal. The coating of walls 5 may have different types of surface reflectivity, including specular and diffuse reflectance or combinations thereof in the UV, visible, or infrared region or combinations thereof.
Sample Holder/Cuvette 7: The cuvette 7 is held in the apparatus 1 via a holder that clamps around the cuvette 7 and also allows the cuvette 7 to be suspended within the cavity 3 at a fixed position. The following cuvette geometries may be provided: standard (1 cm square), thin or plate-like (10×1 mm), cylindrical, spherical (combinations are possible too, e.g. cylindrical with a flat region).
USB Spectrometer 11: Analyzes the intensity of the light leaving the cavity 3 as a function of wavelength, allowing a spectrum to be obtained and displayed on, for example, a computer screen. This may be a standalone device powered and interfaced via USB connection to a controller in the form of a laptop/computer. Light detection may be as per a standard spectrometer with dispersive optics and detection via CMOS, CCD, diode-array, or scanning-monochromator.
Electronics: The movable mirrors are driven by stepper motors, and controlled by programmable micro-controller with stepper motor driver board. Both micro-controller and the USB spectrometer are attached to a controller such as a mini-computer internal to the apparatus 1. The purpose of the mini-computer is two-fold, i) it facilitates communication with the spectrometer 11 and with the motor driver, and ii) it provides a web-based graphical user interface. This facilitates interaction with the apparatus 1 in that there is no need for the user to install special software, and no need for the developer to maintain operating-system dependent custom software.
Light sources: standard UV-VIS (i.e. Halogen, Xenon, Deuterium lamps), LEDs of any sort, lasers, combinations of all these; and any polychromatic source with attached monochromator for wavelength selection.
Delivery optics: assemblies of standard optical components such as lenses, mirrors, shutters, diffraction gratings, optical fibers, or any combinations thereof.
Light-path switching: Motorized linear stage(s) and/or shutter(s).

### Parameters/Variables

There are a number of physical and geometrical parameters/variables which are factors in the design and operation of a dissolution analyzer 1 as described above, which include any one or more of the following:
Cavity Surface reflectivity p is the ratio of reflected to incident light rays. For the operation of the cavity in line with dissolution analyzer 1, the reflectivity must be close to unity, i.e. the walls 5 comprise highly reflective material. The apparatus 1 further requires the reflectivity to be strongly diffuse (Lambertian).
Port fraction f is the ratio of the surface area of all cavity ports P1-P4 to the total surface area of the walls 5 of the cavity 3. A ray of light randomly traversing the cavity 3 thus has a chance f to escape.
Enhancement factor M: approximately encodes the number of diffuse cavity surface reflections a ray will undergo before either absorbed by the walls of the cavity or leaving via a port. In the ideal case of an empty spherical cavity we have M=ρ/1−ρ(1−f).
Chance to hit the sample u: a purely geometric factor, states the probability for a ray which diffusely reflected off the cavity surface to interact with the sample cuvette.
Path-length L is the average length of the path a ray of light takes within the sample volume. L is large if M and i are large.

### Apparatus Calibration/Measurements/Control Overview

The following factors form the basis for the dissolution analyzer 1 in order to obtain error free spectra:
Relating to absorbance measurements:
The controller determines the absolute absorption cross-section of samples inserted into an integrating cavity; this requires accurate calibration of measurable intensities against known standards.
Input port positions for absorbance: There are two options for the placement of this port:
   i) Avoiding direct illumination of the sample improves reproducibility of measurements as it is less sensitive on the exact geometric replacement of the sample cuvette. The disadvantage of this approach is that some light reaches the detector (determined by u) without interacting with the sample, even for a fully absorbing sample, which limits the range of measurable optical density.
   ii) Alternatively all incident rays can be made to pass through the sample. This solves the problem of saturating absorbance and allows the measurement of strongly absorbing samples. In this case the detection port needs to collect from a section of the cavity wall which does not receive light from direct or reflected illumination.
Detection port positions for absorbance: The field of view of the detection port must not intersect the sample, instead it should gather light only from the cavity surface. This minimizes the dependence of the measurement on the scattering properties of the sample.
Geometric optimization of the setup: the average pathlength in the sample, L, can be approximated by the ratio of the sample volume and the cavity volume, rV=Vₛₐₘₚₗₑ/V_{cavity} multiplied by the average chord length in the cavity, c′=4 V_{cavity}/A_{cavity} (where A_{cavity} is the surface area of the cavity), and by the enhancement factor M. The approximate pathlength L=rVc′M governs the lower limits of the detectable optical density; for example, for low-absorbance samples it is desirable to maximize L: i) M becomes maximal for a cavity surface reflectivity p→1 and cavity port fraction f→0, ii) rV increases with the relative sample volume and approaches one as the sample fills the sphere entirely, iii) c′ is maximal for a spherical cavity. A spherical cavity filled entirely by the sample, with maximal surface reflectivity and minimal port openings may be an optimal setup for detection of ultra-low concentrations.
It is not straight-forward to choose a combination of parameters (cavity and sample geometries, port locations, numerical apertures, etc.) which fit the requirements of validity, reproducibility, and user-convenience. The design choices may be a non-trivial compromise. For example, the dissolution analyzer 1 described above is suited for standard cuvettes, including cuvettes with short optical pathlength for strongly absorbing liquids.
Relating to combined extinction-absorbance measurements:
extinction measurements are performed inside an integrating cavity; this comes with geometric constraints in that the sample walls must be perpendicular to the incident beam, which requires a square or flat-walled cuvette. Cuvettes with curved surfaces (e.g. cylindrical) are also possible, but would require specialized optics to counter the refractive effects.
The numerical aperture available in both delivery and detection needs to be constrained in order to avoid diffuse illumination of the sample and to minimize detection of multiple-scattering light.
Combined delivery and detection optics capable of switching between the absorption and extinction pathways are required. The arrangement of these pathways must ensure that they do not affect each other.

### Apparatus Calibration/Measurements/Control Example Detail

Detail of an example calibration method that could be used to calibrate a dissolution analyzer as described above, is set out in the Appendix disclosed in international patent application WO2018070882, the entire contents of which are fully incorporated herein by reference.

The dissolution analyzer may be configured to measure spectra of a liquid sample selected from any one or more of the following:
a. Water;
b. A beverage;
c. An edible liquid or partially liquid product;
d. Water, such as seawater;
e. A solution,
f. A suspension,
f. Emulsions;
g. Blood

In some embodiments, the dissolution analyzer 1 does not include the input light path adjuster 13 and/or the output light path adjuster 13B. The dissolution analyzer 1 does not include the components that enables a transmission mode operation where the liquid sample is directly illuminated in order to determine the wavelength dependent extinction spectrum of the liquid sample. The dissolution analyzer 1 include the components that only enables the diffusely reflecting mode operation to determine the wavelength dependent true absorbance spectrum of the liquid sample. Additionally, the integrating cavity may only include an input port P2 and an output port P4 arranged for such absorbance measurements. This allows a less complex dissolution analyzer 1 to be provided.

The present disclosure also concerns a dissolution analysis or monitoring method, or a dissolving activity analysis or monitoring method for measuring, monitoring or analyzing at least one substance during dissolution of the at least substance SB into a liquid, liquid matrix or liquid sample, or for measuring, monitoring or analyzing at least one substance SB that is dissolving into a liquid, liquid matrix or liquid sample.

The method comprises providing the dissolution analyzer 1 or the dissolving activity analyzer 1 as previously disclosed, and using the dissolution analyzer 1 to carry out absorbance related measurements in the diffusely reflecting operation mode during a release of at least one substance, item or ingredient SB from at least one carrier CR into the at least one liquid or liquid matrix LQ contained in a liquid sample.

Multiple measurements are, for example, carried out in the diffusely reflecting operation mode over a given or determined time duration. Such measurements are provided to the spectrometer 11 and analysis/processing is performed to process the light received by the spectrometer for wavelength analysis of the light to provide or compute at least one or a plurality of (absolute or real) absorbance spectrum of the liquid sample contained in the cuvette. Extinction spectra may also be determined and provided.

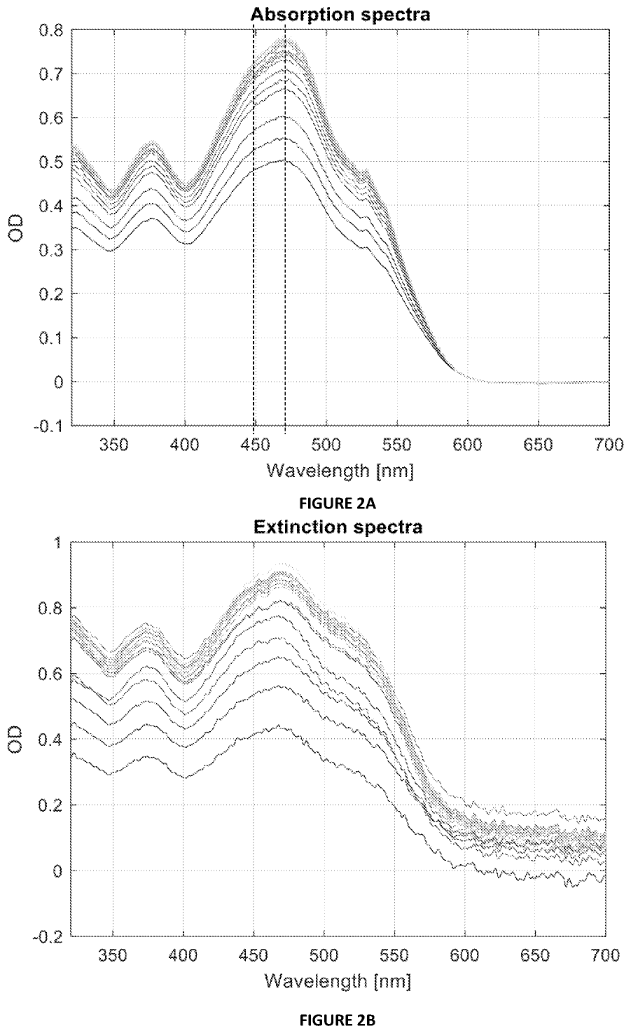

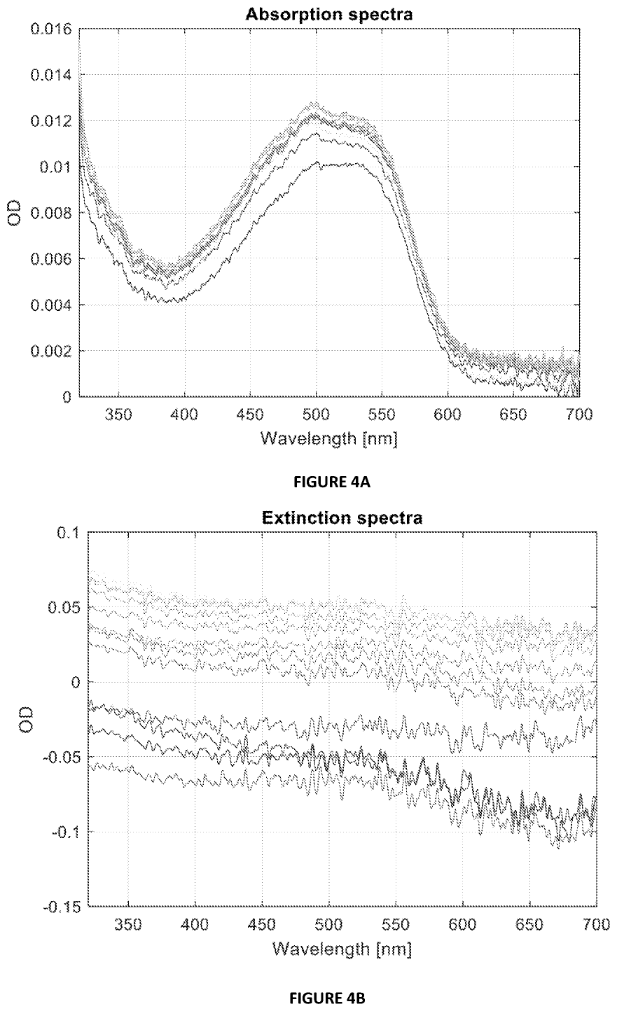

At least one or a plurality of the (absolute or real) absorbance spectrum are determined or provided over the given or determined time duration (see for example FIGS. 2A and 4A). This time duration preferably allows, for example, a complete dissolution or release process to be measured, or a significant portion of the dissolution or release process to be measured or determined via the absorbance spectra to allow dissolution characteristics of the substance or item into the liquid or liquid matrix to be determined.

Each absorbance spectra may, for example, be determined after a determined time interval, the time interval may be of a fixed or constant value, or may vary depending on the release evolution stage. For example, the time interval may initially be smaller and increased to a larger value at a later stage of the release or diffusion process.

The light spectrum measurement is, for example, performed over a broad wavelength range, for example, a broad UV-visible wavelength range. The wavelength range may be, for example, 300 nm to 900 nm, or 300 nm to 700 nm.

This allows to spectrally determine/identify the spectral location of a release behavior in the features of the broad wavelength spectrum, and allows to then analyze characteristic release or dissolving behaviors at one or more dissolution behavior specific wavelengths, or in one or more dissolution behavior (narrower) wavelength ranges.

The dissolution analyzer 1 is operating in a diffuse reflection mode as explained previously in this disclosure. The light source is activated, and after having passed the diffused light through the cuvette 7 inside the integrating cavity 3, wavelength analysis is carried out of the light transmitted through the light outlet port and to the spectrometer, to provide an absorbance spectrum or spectra of the liquid sample contained in the cuvette.

The dissolution analyzer 1 is operating in a diffuse reflection mode in which light from the light source 9 follows a light path from the or one of the inlet port(s) into the integrating cavity 3, is incident onto reflective inner wall or walls 5 of the integrating cavity 3 and is diffusely reflected within the integrating cavity 3, such that the light from the light source irradiates the liquid sample and liquid or liquid matrix during substance release, before being transmitted through the or one of the light outlet port(s) and received by the spectrometer 11 for wavelength analysis of the light and to provide an absorbance spectrum of the liquid or liquid matrix contained in the liquid sample.

Reference spectrums in which the dissolving substance or carrier CR is absent in the liquid or liquid matrix and a dark spectrum are, for example, used in the determination of the (real) absorbance spectrum, as described in the measurement procedure described in international patent application WO2018070882, the entire contents of which are fully incorporated herein by reference. The dissolution analyzer 1 is configured to determine/compute extinction and (measured) absorption spectra of a n^{th} sample (for example, via or by the electronic controller/software) according to:

$${E}^{n} ( λ ) = - {log}_{10} ( \frac{{I}_{S}^{E} ( λ ) - {I}_{D} ( λ )}{{I}_{R}^{E} ( λ ) - {I}_{D} ( λ )} ) \\ {A}_{m}^{n} ( λ ) = - {log}_{10} ( \frac{{I}_{S}^{E} ( λ ) - {I}_{D} ( λ )}{{I}_{R}^{E} ( λ ) - {I}_{D} ( λ )} )$$

where:
I_{S}^{E}(λ) is the intensity of light transmitted by the sample measured in extinction mode;
I_{R}^{E}(λ) is the intensity of light transmitted by a reference solution measured in extinction mode;
I_{R}^{A}(λ) is the intensity of light transmitted by a reference solution measured in absorbance mode;
I_{D}(λ) is the intensity measured in a dark mode in which the light source is switched off.

The (real) absorbance spectrum A_{R}(λ) is then determined according to

$${κ}_{eff} ( {A}_{R} ( λ ) ) = \frac{{A ( λ )}_{MEAS}}{{A}_{R} ( λ )} ,$$

as disclosed on pages 23 to 27 of international patent application WO2018070882, the entire contents of pages 23 to 27 are fully incorporated herein by reference.

The integrating cavity 3 is configured to receive and hold the cuvette 7 within the integrating cavity, the cuvette 7 containing the liquid or liquid matrix and thus containing the liquid sample within the integrating cavity 3. The substance, item or ingredient SB is being released to the liquid, liquid matrix inside the cuvette 7, while the cuvette 7 is held within or received inside the integrating cavity 3.

The substance, item, or ingredient SB is held, carried, or contained in at least one (substance) carrier or at least one (substance) substrate CR. The substance item, or ingredient CR is released from the carrier or substrate CR when the carrier or substrate, or a portion thereof, is placed into the liquid or liquid matrix contained in cuvette 7.

The carrier or substrate CR (or a portion thereof) containing the at least one substance, item or ingredient SB to be released into the liquid or liquid matrix can be, for example, inserted into the cuvette 7 prior to positing the cuvette 7 into the integrating cavity 3, or alternatively while the cuvette 7 is already positioned inside the integrating cavity 3, the cuvette preferably may already contain the liquid or liquid matrix, or the liquid or liquid matrix may be added in addition to the carrier or substrate CR.

As previously mentioned, the substance, item or ingredient SB release generates turbidity or light scattering in the liquid, liquid matrix or liquid sample.

The absorbance spectrum is an absolute absorbance spectrum or the true absorbance spectrum described above in which the diffusely reflecting mode operation of the dissolution analyzer 1 is used to determine the wavelength dependent true absorbance spectrum of the liquid sample into which the substance, item or ingredient SB is being released.

The at least one substance, item or ingredient SB to be dissolved in the at least one liquid or liquid matrix is inserted into the at least one liquid or liquid matrix LQ, and a plurality of absorbance spectrum related measurements are carried out over time during dissolution into the at least one liquid or liquid matrix.

A substance, item or ingredient SB release profile or dissolution curve of the at least one substance SB into the at least one liquid or liquid matrix can be determined based the plurality of absorbance spectra determined or provided over a measurement time duration during release or dissolving of the substance SB into the liquid or liquid matrix. This can, for example, be done by identifying or determining a release or dissolving characteristic/behavior in the spectrum that may be present at one or more dissolution behavior specific wavelengths, or in one or more dissolution behavior (narrower) wavelength ranges. For example, this could be at a wavelength or in wavelength range where a maximum optical absorption is being measured, or at a wavelength within ±5° or 10% of this maximum). However, it should be understood that other selection criteria may be used. This is often substance dependent. The wavelength or wavelength range is, for example, characteristic of the presence of the substance in the liquid or liquid matrix.

The evolution of the optical absorption value, over a time duration, at this release or dissolving characteristic wavelength or release or dissolving characteristic wavelength range is determined (see for example, FIG. 2C). This is one non-limiting exemplary manner permitting a release profile or dissolution curve of the substance into the liquid or liquid matrix to be determined.

In the case where a plurality of different substances, items or ingredients are being released, a release profile or dissolution curve may be determined for each one based on a release or dissolving characteristic wavelength or release or dissolving characteristic wavelength range determined and attributed to each substance, item or ingredient.

A comparison of the determined release profile or dissolution curve can be carried out with respect to a target/standard release profile or target/standard dissolution curve that the dissolving/release process is expected to match or correspond to.

A conformity between the determined release profile or dissolution curve and the target release profile or target dissolution curve can then be determined or established, and a correspondence score determined based on the degree of similarity between the measured and the target release profile or target dissolution curve.

Dissolution tests were carried out using the dissolution analyzer 1 having the integrating-cavity based spectrophotometer described herein.

The dissolution analyzer 1 can produce two spectra of the liquid sample being measured simultaneously; the first spectrum is the “extinction spectrum”, where the sample is measured in a transmission geometry and, as mentioned previously, a reduction in light intensity occurs that is a result of sample absorbance and scattering. This is the equivalent spectrum produced by a traditional UV-Vis spectrophotometer. The second spectrum is the “absorption spectrum”, where the sample is measured in the integrating-cavity geometry and the reduction in light intensity is a result of sample absorbance only.

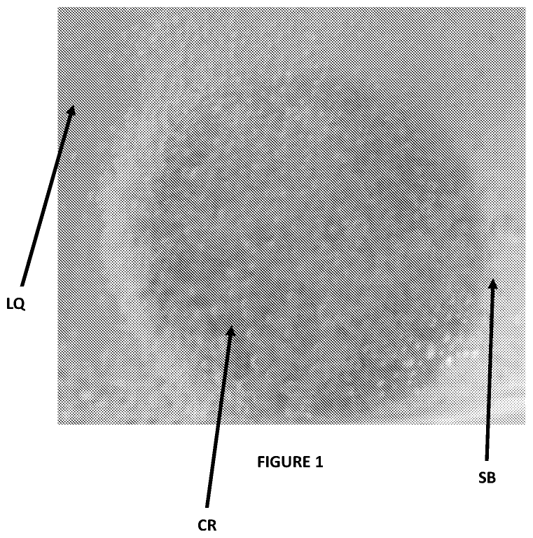

In an exemplary approach demonstrating the operation and advantage of the dissolution analyzer according to the present disclosure, the Inventors studied the time evolution of the spectrum during dissolution into water of the substance of an exemplary carrier CR that is an effervescent tablet, the tablet containing berry-flavored vitamin B&C supplement, that is dissolved or released into water. An exemplary image is provided in FIG. 1 showing the carrier CR in water, and showing the dissolution or release process of the substance SB.

To measure or analyze the dissolution or release process, the Inventors set the number of spectra to be determined to 100 in order to have sufficient time resolution to monitor the dissolution process.

The Inventors then measured 1 ml water as reference (10 mm cuvette). They then dropped a small amount (a few grains) of the tablet in the cuvette 7, closed a tower of the dissolution analyzer 1 covering the cuvette 7, and started a measurement, then restarted the measurement as soon as it was finished (approx. every 5.5 seconds), then more sparsely later. For each experiment, the full extinction and absorption spectra were measured as a function of wavelength, from 300 nanometers to 700 nanometers. A specific region of interest, based on the spectral profile of the substance, was then chosen to monitor the time dependence of the substance dissolution. For the berry flavoured samples, 469 nm was chosen and for the orange flavoured samples, 448 nm was chosen.

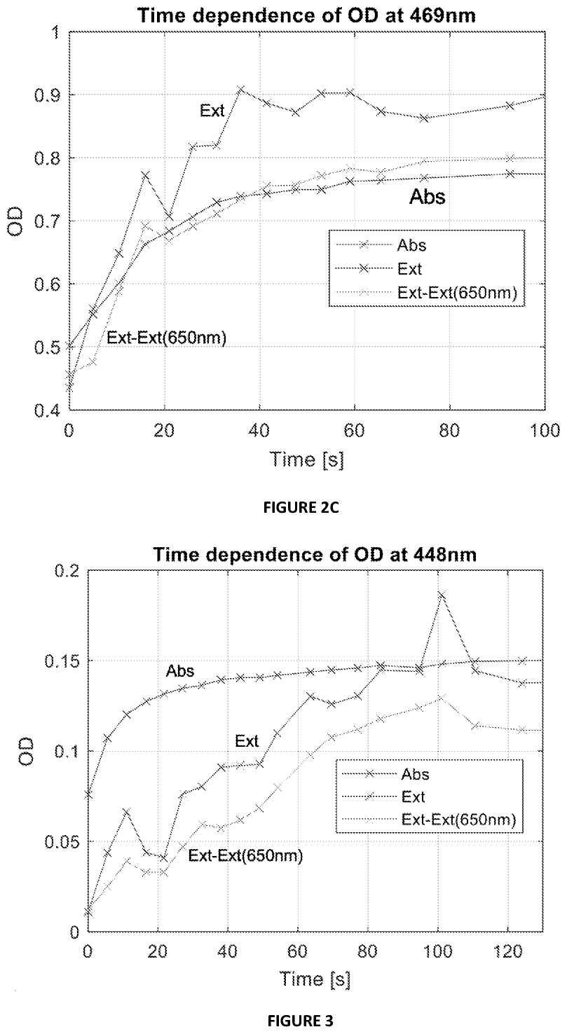

The results for the berry flavored sample are shown in FIGS. 2A to 2C, and for the orange flavored samples are shown in FIG. 3.

The bubbles strongly affect the extinction results because of scattering, as demonstrated in the dissolution curve labelled “Ext”. The presence of bubbles in the extinction beam is random and this creates strong fluctuations. It appears from the results that this cannot be corrected by simple baseline subtraction, as demonstrated in the dissolution curve labelled “Ext-Ext (650 nm), where the extinction value at 650 nm has been subtracted from the 469 nm extinction value.

Attempting to remove a background turbidity using a background subtraction from the UV-Vis based results is insufficient to obtain a smooth dissolution curve that is unaffected by sample turbidity.

In contrast, the absorption value increases smoothly and reflects much more reliably the increase in concentration of the released active substance, as demonstrated in the dissolution curve labelled “Abs”.

Also notable is that the extinction is lower than absorption at early time. This is because the extinction only probes the central region where the beam crosses, while the absorption is sensitive to the entire volume in the cell, so is not susceptible to inhomogeneity in the sample or settling of particulates.

The effect of turbidity on dissolution curves has not been studied before and has only now been demonstrated in this disclosure by the Inventors using an integrating cavity to obtain the “true absorbance” of the sample and simultaneously make a comparison with the traditional UV-Vis based results.

FIG. 3 shows the result for the same experiment with the orange-flavoured supplements, and one arrives at similar conclusions.

Spectra for a vitamin C supplement are shown in FIGS. 4A and 4B. The values at spectra below 300 nm are significantly strong and saturation occurs so here focus was placed on the visible part of the spectrum.

This highlights another advantage of the dissolution analyzer and dissolution measurement method of the present disclosure; the enhanced sensitivity to low-absorbing samples. Here the peak at 500 nm is barely distinguishable in extinction, while it is clearly observed in absorption despite its peak OD of about 0.01.

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

Any discussion of the prior art throughout the specification should in no way be considered as an admission that such prior art is widely known or forms part of common general knowledge in the field.

While the invention has been disclosed with reference to certain preferred embodiments, numerous modifications, alterations, and changes to the described embodiments, and equivalents thereof, are possible without departing from the sphere and scope of the invention. The features of any one of the described embodiments may be included in any other of the described embodiments. The methods steps are not necessary carried out in the exact order presented above and can be carried out in a different order. Accordingly, it is intended that the invention not be limited to the described embodiments, and be given the broadest reasonable interpretation in accordance with the language of the appended claims.

1-50. (canceled)

51. Dissolution analysis method for measuring, monitoring or analyzing at least one substance during dissolution of the at least one substance into at least one liquid or liquid matrix contained in the liquid sample, the method comprising the steps of:
providing a dissolving activity analyzer, for measuring, monitoring or analyzing substance dissolution into a liquid or liquid matrix, the dissolving activity analyzer including:
an integrating cavity comprising a reflective inner wall or walls, and configured to receive a cuvette containing liquid sample within the integrating cavity,
wherein the integrating cavity comprises at least one light inlet port and at least one light outlet port, the light inlet port or each light inlet port being configured to receive light from at least one light source and the light outlet port or each light outlet port being configured to deliver light to a spectrometer;
wherein the dissolving activity analyzer is configured to operate in a diffusely reflecting mode in which light from the light source follows a light path from the inlet port or one of the inlet ports into the integrating cavity, is incident onto the reflective inner wall or walls of the integrating cavity and is diffusely reflected within the integrating cavity, such that the light from the light source irradiates the liquid sample before being transmitted through the light outlet port or one of the light outlet ports and received by the spectrometer for wavelength analysis of the light to provide an absorbance spectrum of the liquid or liquid matrix contained in the liquid sample; and
carrying out measurements using the dissolving activity analyzer in the diffusely reflecting operation mode during release of the at least one substance into the at least one liquid or liquid matrix contained in the liquid sample.

52. Dissolution analysis method according to claim 51, wherein the measurements are a plurality of absorbance spectrum related measurements that are carried out on the at least one liquid or liquid matrix during substance release.

53. Dissolution analysis method according to claim 52, wherein at least one substance carrier containing the at least one substance to be dissolved in the at least one liquid or liquid matrix is inserted into the at least one liquid or liquid matrix, and a plurality of absorbance spectrum related measurements are carried out in the diffusely reflecting operation mode over a time duration during dissolution of the at least one substance into the at least one liquid or liquid matrix.

54. Dissolution analysis method according to claim 53, wherein a plurality of absorbance spectrum are determined over a time duration during dissolution of the at least one substance into the at least one liquid or liquid matrix.

55. Dissolution analysis method according to claim 54, wherein a release profile or dissolution curve of the at least one substance into the at least one liquid or liquid matrix is determined based the plurality of absorbance spectrum.

56. Dissolution analysis method according to claim 55, wherein the release profile or dissolution curve of the release of the at least one substance into the at least one liquid or matrix is determined based on the evolution of an absorption value of the determined absorption spectrum at a specific wavelength or wavelength range that is characteristic of the presence of the at least one substance in the liquid or liquid matrix.

57. Dissolution analysis method according to claim 56, wherein the release profile or dissolution curve is determined at one specific wavelength value or range.

58. Dissolution analysis method according to claim 57, wherein a comparison of the determined release profile or dissolution curve is carried out with respect to a target release profile or target dissolution curve.

59. Dissolution analysis method according to claim 58, wherein a conformity between the determined release profile or dissolution curve and the target release profile or target dissolution curve is established.

60. Dissolution analysis method according to claim 51, wherein the at least one substance generates turbidity in the at least one liquid or liquid matrix.

61. Dissolution analysis method according to claim 51, comprising steps of:
activating the light source; and
conducting wavelength analysis of the light transmitted through the light outlet port via the spectrometer for wavelength analysis of the light to provide an absorbance spectrum or spectra of the substance dissolving in the liquid sample contained in the cuvette.

62. Dissolving activity analyzer for measuring, monitoring or analyzing substance dissolution into a liquid or liquid matrix, the dissolving activity analyzer including:
an integrating cavity comprising a reflective inner wall or walls, and configured to receive a cuvette containing liquid sample within the integrating cavity,
wherein the integrating cavity comprises at least one light inlet port and at least one light outlet port, the light inlet port or each light inlet port being configured to receive light from at least one light source and the light outlet port or each light outlet port being configured to deliver light to a spectrometer;
wherein the dissolving activity analyzer is configured to operate in a diffusely reflecting mode in which light from the light source follows a light path from the inlet port or one of the inlet ports into the integrating cavity, is incident onto the reflective inner wall or walls of the integrating cavity and is diffusely reflected within the integrating cavity, such that the light from the light source irradiates the liquid sample before being transmitted through the light outlet port or one of the light outlet ports and received by the spectrometer for wavelength analysis of the light to provide an absorbance spectrum of the liquid or liquid matrix contained in the liquid sample.

63. The dissolving activity analyzer according to claim 62, further including a light path adjuster configured to selectively adjust a light path through the integrating cavity such that at least two distinct light paths are provided;
wherein when the light path adjuster is in a first configuration, the dissolving activity analyzer is in a transmission mode in which light from the light source follows a first light path from the or one of the light inlet port(s) to the liquid sample such that the light from the light source irradiates the liquid sample directly before the light transmitted by the sample is transmitted through the or one of the light outlet port(s) and received by the spectrometer for wavelength analysis of the light to provide an extinction spectrum of the liquid sample; and
when the light path adjuster is in a second configuration, the dissolving activity analyzer is in the diffusely reflecting mode in which light from the light source follows a second light path from the inlet port or one of the inlet ports into the integrating cavity, is incident onto the reflective inner wall or walls of the integrating cavity and is diffusely reflected within the integrating cavity, such that the light from the light source irradiates the liquid sample before being transmitted through the or one of the light outlet port(s) and received by the spectrometer for wavelength analysis of the light to provide an absorbance spectrum of the liquid or liquid matrix contained in the liquid sample.

64. The dissolving activity analyzer of claim 63 arranged such that, light is transmitted:
a. directly from the inlet port onto the wall or walls of the integrating cavity; and
b. directly from the inlet port, onto and through the sample and subsequently onto the wall or walls of the integrating cavity.

65. The dissolving activity analyzer of claim 63 wherein the inlet port used in the first configuration is directly opposed from the outlet port used in the first configuration such that, when in the first configuration, the first light path extends directly across the integrating cavity.

66. The dissolving activity analyzer of claim 63 further comprising a controller configured to control the light path adjuster to selectively adjust the path of light through the dissolving activity analyzer.

67. The dissolving activity analyzer of claim 66 wherein the controller is configured to control the spectrometer and to provide the extinction and absorbance spectrum of the liquid sample contained in the cuvette.

68. The dissolving activity analyzer of claim 62 comprising a sample holder configured to retain a cuvette containing liquid sample within the integrating cavity.
